(19) United States
(12) Patent Application Publication
(10) Pub. No.: US 2025/0048975 A1
(43) Pub. Date: Feb. 13, 2025

(54) LANDSCAPE MAINTENANCE SYSTEMS AND METHODS

(71) Applicant: Theodore R. Steinke, Golden, CO (US)

(72) Inventor: Theodore R. Steinke, Golden, CO (US)

(21) Appl. No.: 18/926,074

(22) Filed: Oct. 24, 2024

Related U.S. Application Data
(63) Continuation of application No. 17/535,194, filed on Nov. 24, 2021.
(60) Provisional application No. 63/117,731, filed on Nov. 24, 2020.

(51) Int. Cl. A01G 20/47; A45F 3/14; A47L 5/14; A47L 5/36; A47L 9/06; A47L 9/08; A47L 9/14; A47L 9/24; A47L 9/32

(52) U.S. Cl. CPC A01G 20/47; A45F 3/14; A47L 5/14; A47L 5/365; A47L 9/0606; A47L 9/08; A47L 9/1418; A47L 9/1427; A47L 9/248; A47L 9/327; A45F 2003/146

(57) ABSTRACT

Systems and methods for maintaining landscape features. Exemplary landscape maintenance systems include an air flow generation mechanism such as a vacuum and/or blower, a wand assembly having a forearm cuff assembly and a joystick handle assembly, and a nozzle assembly having an agitator assembly. The agitator assembly may include one or more spines or leaflets. The air flow generation mechanism may include a port in fluid communication with the wand assembly. The air flow generation mechanism may also include a port in fluid communication with an exhaust conduit, the exhaust conduit may be attached with a receptacle bag, and the receptacle bag may have a bag frame disposed therein.

### CROSS-REFERENCES TO RELATED APPLICATIONS

This application is a continuation of U.S. patent application Ser. No. 17/535,194 filed Nov. 24, 2021, which claims the benefit of U.S. Provisional Patent Application No. 63/117,731 filed Nov. 24, 2020. The disclosures of each of the applications listed above are incorporated herein by reference.

### BACKGROUND OF THE INVENTION

Embodiments of the present invention relate to the field of landscape maintenance, and in particular embodiments, to vacuum and blower devices and methods.

Landscape maintenance devices can be used to vacuum and/or blow leaves and other materials. Although currently known landscape systems and methods are useful in many situations, still further improvements are desired. Embodiments of the present invention provide solutions to at least some of these outstanding needs.

### BRIEF SUMMARY OF THE INVENTION

Embodiments of the present invention include landscape maintenance systems and methods that can be used in any of a variety of landscaping situations. In some cases, exemplary backpack leaf blower systems are well suited for use in providing air penetration deeply into cracks between rocks in decorative rock beds, in agitating rocks sufficiently enough to loosen leaves, dirt, and other debris without causing saltation and ejection of rocks from boundaries of rock beds. In this way, leaf blower systems can be used to clean deeper layers of rock, without tending to saltate and eject top layer of rocks along with debris. Moreover, exemplary backpack leaf blower systems can include forearm cuff devices which provide additional control and comfort, and can enhance the operator's ability to reach under shrubs, bushes, and low trees, other areas that may be difficult to otherwise access. Exemplary blower systems can include agitators and angled heads, long extension wands, and/or forearm swings to achieve any one or more of the objectives described herein.

Exemplary vacuum systems, which may involve the use of a shop vac, can be used to skim the easy, loose debris off the top of rock bed, in addition to removing debris that is deep and/or stuck to or between rocks, without sucking up unwanted amounts of rock along with the debris in a “baby-out-with-the-bathwater” scenario. Exemplary vacuum systems can be used to easily stir or agitate rocks to get deep trapped debris. Moreover, exemplary vacuum systems are configured for easy adjustment, so as to readily accommodate a wide variety of types of debris and/or rocks in different situations. Further, exemplary vacuum systems avoid or ameliorate clogging problems associated with larger debris or with rocks. What is more, exemplary vacuum systems avoid causing the operator to suffer fatigue in their wrist, shoulder, and/or back, which may otherwise occur when using conventional hand-held vacuum tubes. Still further, exemplary vacuum systems provide enhanced levels of control over longer tube strings which are sometimes necessary to reach under trees and shrubs. Advantageously, exemplary vacuum systems are configured to keep the nozzle at a particularly desired distance off the ground, so as to enable the effective skimming of debris off the top of the rock bed. In some embodiments, landscape maintenance systems can include trash bag frames, which can prevent or inhibit trash bags in a debris receptacle from covering the exhaust air outlet. According to some embodiments, exemplary nozzle agitators can allow rocks to be stirred to loosen up deep, trapped debris. Exemplary nozzle agitators can also provide a particular desired distance off rock beds to skim debris off top. Exemplary adjustable flow regulators can allow a particularly desired amount of vacuum force and flow to reduce the percentage of rocks sucked in with the debris. Exemplary rock extractor devices are configured to allow rocks that happen to be sucked into the system to be easily separated and removed from the debris.

Exemplary vacuum/blower combination systems, such as leaf vacuum/blower combination systems, can include mechanisms that effectively operate to agitate or stir the rocks in the rock bed. Thus, they are efficient at removing deep debris or debris stuck between rocks. They are relatively light weight, and can include forearm swing mechanisms. Hence, they can avoid problematic issues associated with other known systems, which are supported or held and swung by hand and wrist, making such other systems awkward and fatigue-inducing.

Embodiments of the present invention encompass leaf vacuum/blower conversion system that can be used to convert any leaf vacuum/blower combo unit into a backpack-supported unit, thus reducing fatigue. Exemplary conversion systems can add a forearm-swung wand with multiple nozzle attachment possibilities, for example including nozzles of various diameters, allowing greater control and reach and adding agitation functionality. In some cases, a conversion system can include a simple lawn leaf vacuum nozzle with an angled head. In some cases, a conversion system can operate to easily be converted from a vacuum configuration to a blower configuration, to help clear clogs and to blow debris when desired.

Exemplary forearm swing conversion kits can be used to convert any backpack leaf blower, handheld leaf blower, handheld leaf vacuum, linear tubular vacuum wand, including Shop Vacs, insulation vacuums, and larger debris vacuums, into forearm swing units. Exemplary forearm swing mechanism can be used with all hand held/swung leaf blowers, thus providing forearm swing unit embodiments thereof. Embodiments also encompass factory built forearm swing leaf blowers, optionally having one or more forearm and grip mechanism features built in, for example a joystick handle assembly and/or an adjustable cuff or forearm cuff assembly.

In one aspect, embodiments of the present invention encompass landscape maintenance systems having an air flow generation mechanism and a nozzle. In some cases, the air flow generation mechanism can include a vacuum device. In some cases, the air flow generation mechanism can include a blower device.

In another aspect, an exemplary landscape maintenance system may include an air flow generation mechanism, a wand assembly, and a nozzle assembly. The nozzle assembly may include an agitator assembly. In particular embodiments, the agitator assembly includes a plurality of agitators. In some cases, the air flow generation mechanism includes a vacuum device. In some cases, the air flow generation mechanism includes a blower device. In some cases, the air flow generation mechanism includes both a vacuum device and a blower device. In some instances, at least one of the plurality of agitators includes an elongate spine and a proximal head. The proximal head may be flattened or otherwise have a diameter that is larger than the diameter of the elongate spine. In some cases, the nozzle assembly includes a flange, and one or more of the plurality of agitators are engaged with the flange. In some cases, the flange includes at least one aperture, and at least one agitator of the plurality of agitators is engaged with the at least one flange aperture. In some cases, at least one agitator includes an elongate spine and a proximal head, and the elongate spine is positioned within the at least one aperture of the flange. In some cases, the nozzle assembly includes a flange cover, and the flange cover is coupled with the flange so as to fix the at least one agitator in place relative to the flange. In some cases, the flange cover is fixed with the flange by at least one lid fastener. In some cases, multiple lid fasteners can be used to secure the flange cover with the flange. In some cases, at least one of the plurality of agitators includes a thin curved leaflet. In some cases, the thin leaflet may be flat. In some cases, the air flow generation mechanism includes an intake port for receiving airflow from the wand assembly, and an exhaust port for delivering airflow into an exhaust conduit. In some cases, the landscape maintenance system includes the exhaust conduit. In some cases, the exhaust conduit is coupled with a receptacle bag. In some cases, the landscape maintenance system includes a bag retention frame disposed at least partially within a receptacle bag. In some cases, a wand assembly includes a forearm cuff assembly and a joystick handle assembly.

In still another aspect, an exemplary landscape maintenance system may include an air flow generation mechanism, a wand assembly having a forearm cuff assembly and a joystick handle assembly, and a nozzle assembly. In some cases, a forearm cuff assembly includes a forearm cradle and a forearm strap. In some cases, a forearm cuff assembly includes an adjustment mechanism in operative association with the forearm strap.

In yet another aspect, an exemplary landscape maintenance system may include an air flow generation mechanism, a wand assembly having a forearm cuff assembly and a joystick handle assembly, and a nozzle assembly having an agitator assembly. The agitator assembly may include at least one elongate spine. In some cases, the agitator assembly includes a flange and a flange cover. In some cases, the flange cover fixes at least one elongate spine in place relative to the flange.

### BRIEF DESCRIPTION OF THE DRAWINGS

FIG. 1A depicts aspects of an exemplary landscape maintenance system, according to embodiments of the present invention.

FIGS. 1B to IN depict aspects of exemplary nozzle assemblies, according to embodiments of the present invention.

FIGS. 2A to 2C depict aspects of exemplary landscape maintenance systems, according to embodiments of the present invention.

FIGS. 2D to 2I depict aspects of exemplary forearm swing conversion kits, according to embodiments of the present invention.

FIG. 3 depicts aspects of an exemplary forearm swing conversion kit, according to embodiments of the present invention.

FIGS. 4A and 4B depict aspects of exemplary forearm swing conversion kits, according to embodiments of the present invention.

FIG. 5 depicts aspects of an exemplary forearm swing conversion kit, according to embodiments of the present invention.

FIGS. 6A to 6D depict aspects of exemplary handheld hand-swung landscape maintenance systems, according to embodiments of the present invention.

FIG. 7 depicts aspects of an exemplary landscape maintenance system, according to embodiments of the present invention.

FIG. 8 depicts aspects of an exemplary bag frame, according to embodiments of the present invention.

FIGS. 9A and 9B depict aspects of exemplary rock extractor system, according to embodiments of the present invention.

### DETAILED DESCRIPTION OF THE INVENTION

All illustrations of the drawings are to be describing selected embodiments of the present invention and are not intended to limit the scope of the present invention. All references of user or users pertain to either individual or individuals who would utilize embodiments of the present invention.

### Vacuum/Blower Nozzles

Exemplary embodiments include rigid agitators to stir the rocks in a rock bed, thus improving the ability to vacuum and/or blow away debris stuck in between rocks.

Exemplary embodiments include an angled head (e.g. in blower mode) to direct airflow downward into rocks for deeper and more efficient removal of debris between rocks. Exemplary embodiments can concentrate air downward into cracks between rocks. Exemplary embodiments can enhance directional and distance control over ejected debris plume. Exemplary embodiments can help reduce rocks ejected from boundaries of rock beds. Exemplary embodiments can operate in vacuum mode to vacuum deeper down into the cracks between rocks.

Exemplary embodiments can include adjustable airflow regulator mechanisms (e.g. in vacuum mode) to adjust the proportion of debris versus rocks sucked into the vacuum, as desired. Exemplary embodiments can be adjusted to suit the type of debris and rock in different situations.

### Rock Extractor

Exemplary embodiments can operate to function as an inline separator of rocks from all other debris sucked into a vacuum system. Exemplary embodiments can attach to the hose part of the vacuum upstream of the debris receptacle. Exemplary embodiments can employ a combination of centrifugal force, reverse Venturi effect, and gravity to separate rocks from all other smaller and/or less dense debris in the vacuum stream.

### Forearm Swing Conversion Kit

Exemplary embodiments include a combination of a rigid wand, a joystick, and a forearm cuff, which can operate to reduce fatigue, increase comfort and control of longer and heavier vacuum tube strings or any vacuum or blower wand or handheld blower or vacuum unit.

### Leaf Vacuum/Blower Conversion System

Exemplary embodiments can operate to add backpack support to any existing leaf vacuum/blower combo unit along with any one or more of the nozzles, rock extractors, forearm and/or swing arms disclosed herein, so as to provide a fully integrated rock bed, lawn, and yard cleaning system. Embodiments of the present invention also encompass larger diameter, leaf-vacuum based systems. Exemplary embodiments can operate to reduce clogs and rocks sucked in with the debris. Exemplary embodiments can include modular sections to help clear clogs.

### Clog Buster

Exemplary embodiments can operate to clear clogs in the nozzle.

### Bag Support

Exemplary embodiments can include bag frames that operate to prevent trash bags from covering an exhaust air outlet.

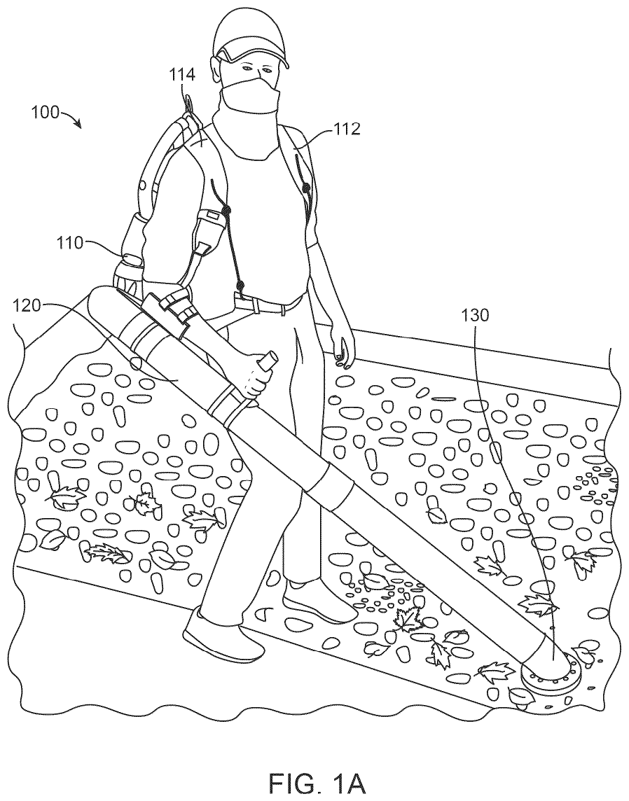

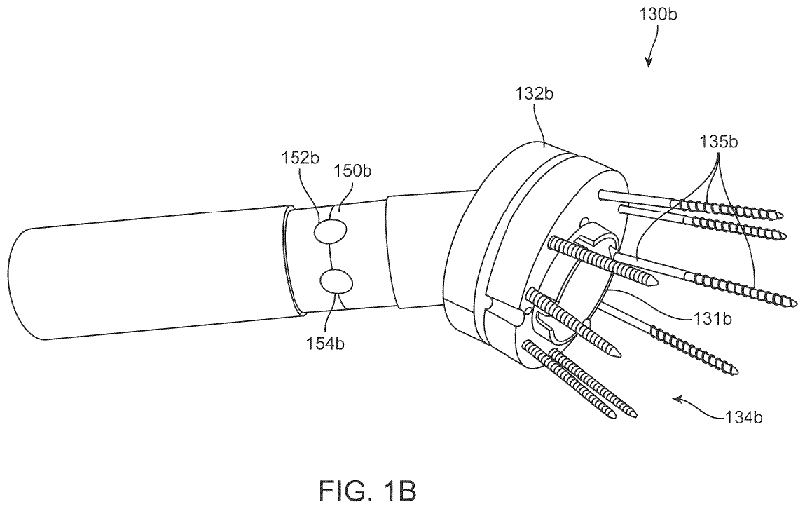

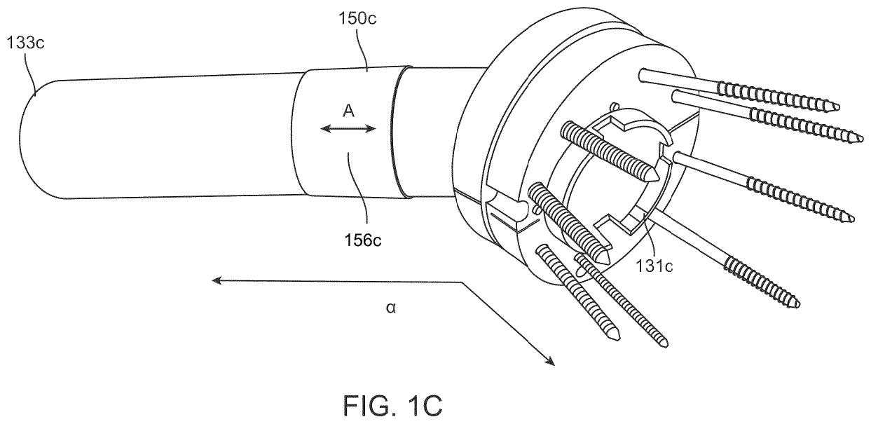

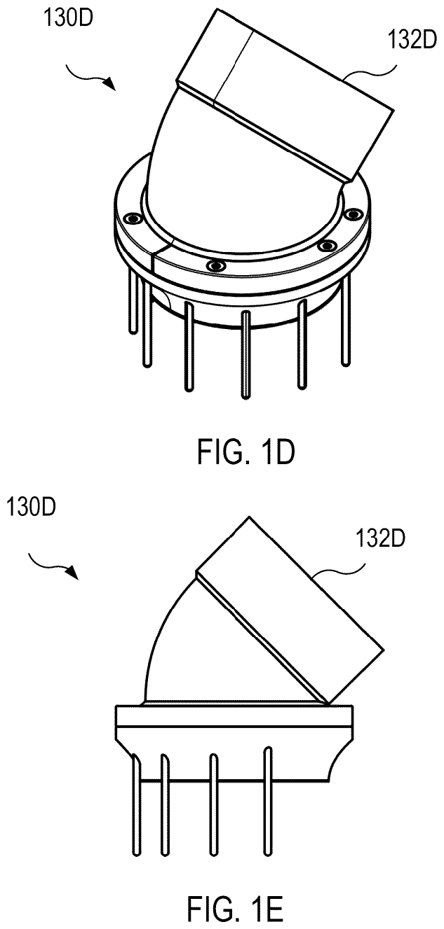

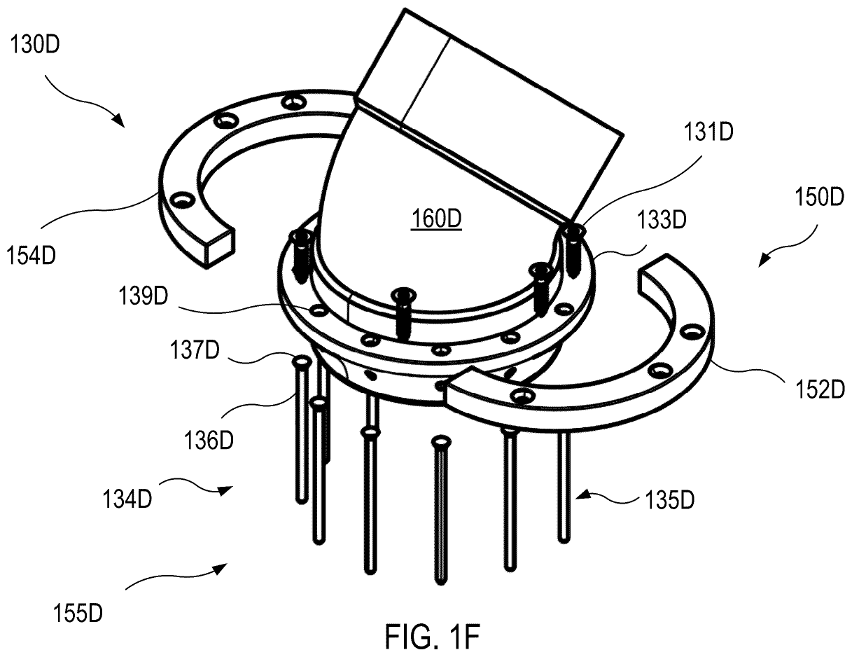

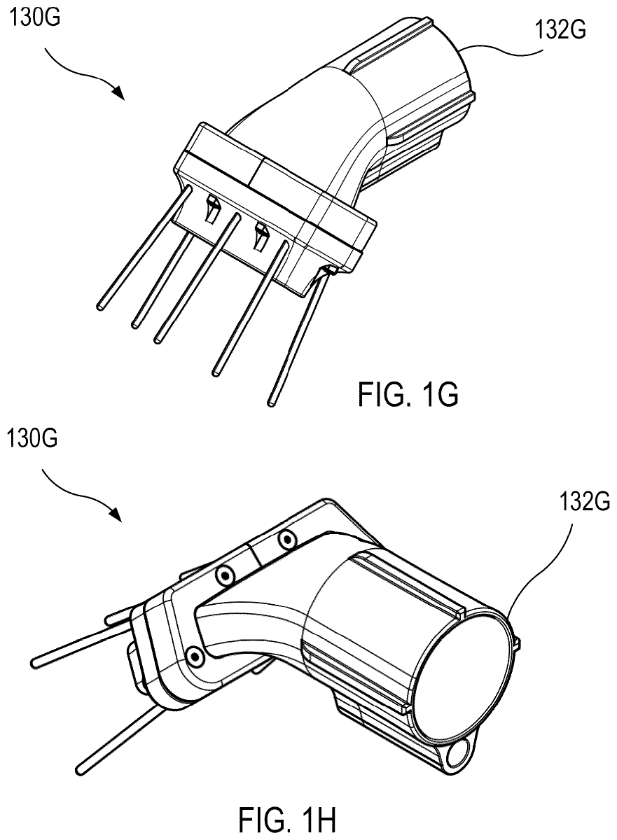

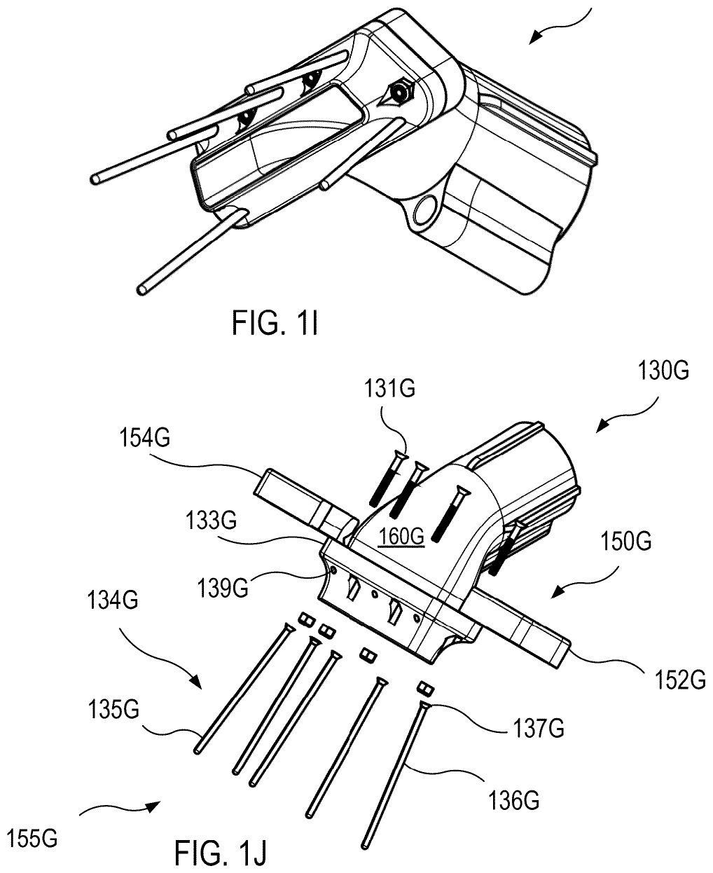

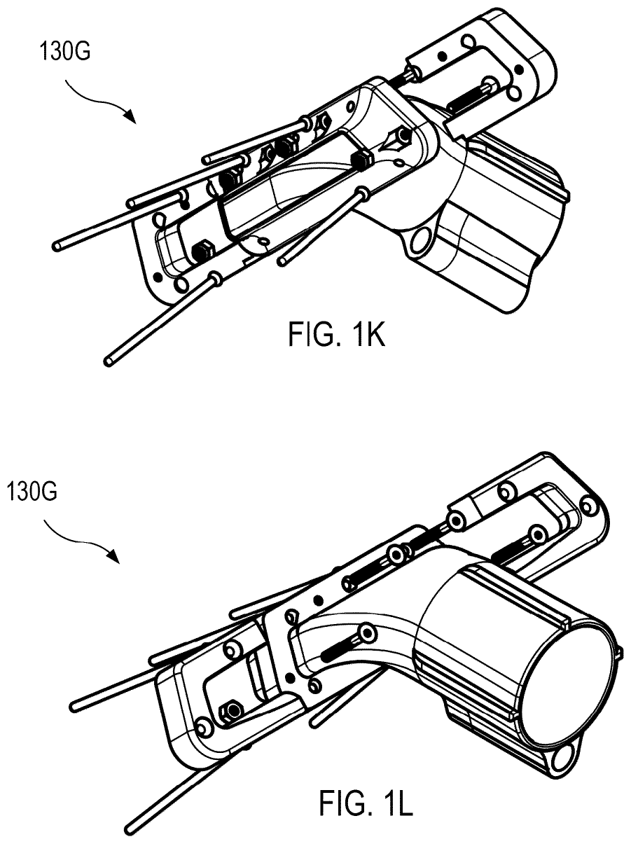

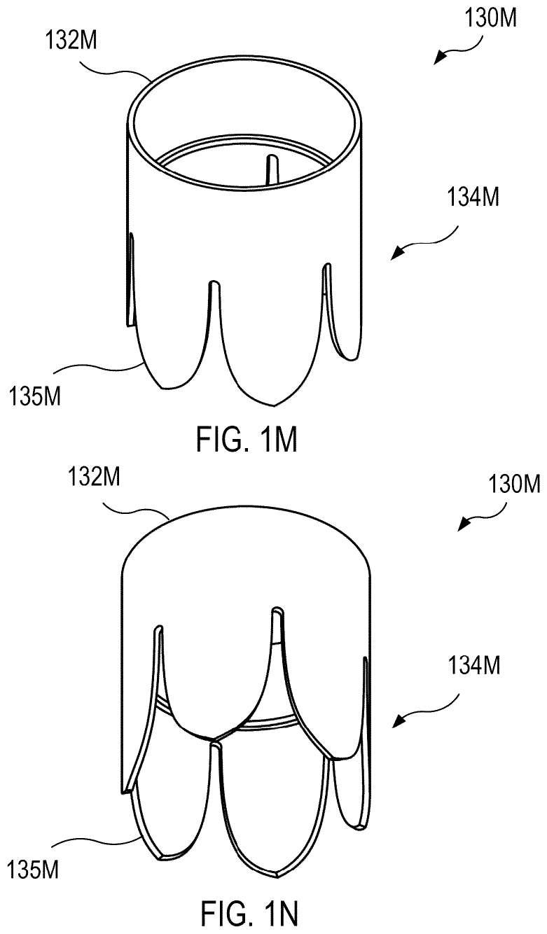

Turning now to the drawings, FIG. 1A depicts aspects of exemplary landscape maintenance systems and methods, according to embodiments of the present invention.

As depicted in FIG. 1A, a landscape maintenance system 100 can include an air flow generation mechanism 110, a wand assembly 120, and a nozzle assembly 130. In some instances, the air flow generation mechanism 110 can be provided as or include a vacuum. In some instances, the air flow generation mechanism 110 can be provided as or include a blower. In operation, the air flow generation mechanism 110 can be worn on the back of the operator, similar to the way a backpack can be worn. As shown here, air flow generation mechanism 110 can include or be attached with a left shoulder strap 112 and a right shoulder strap 114.

In use, the nozzle assembly 130 can provide an effective and efficient tool or solution for removing both surficial debris and debris trapped interstitially between rocks in decorative landscaping rock beds. The wand assembly 120 and/or nozzle assembly 130 can be used in both vacuum and blower applications, and can be configured for use with existing leaf blowers, leaf vacuums, debris vacuums, leaf blower/vacuum combo units, and shop vacuums. The nozzle assembly 130 can be configured to maximize the removal of unwanted debris that has accumulated in decorative rock beds while minimizing the number of rocks that are ejected from the rock bed by pneumatic saltation or sucked up into vacuum debris repositories. According to some embodiments, improved efficacy and efficiency can be achieved by combining multiple technologies into a single system 100. Exemplary technologies include rock agitators, flanges, adjustable airflow regulators, and angled heads. In some cases, the length of a wand assembly may be variable or adjustable. Longer wand lengths may be particularly useful for reaching places which may be otherwise difficult to reach, such as lower ground locations, under trees, or down into window wells.

FIG. 1B illustrates aspects of an exemplary nozzle assembly 130B, according to embodiments of the present invention. As shown here, nozzle assembly 130B includes a flange 132B and an agitator assembly 134B. In this embodiment, the agitator assembly 134B includes a plurality of agitators 135B, such as rock agitators. In some instances, an agitator 135B can be provided as an elongate pin, nail, or screw. In some instances, agitators can be provided as rigid or semi rigid spines configured to facilitate the agitation or stirring of rocks in a rock bed to allow vacuuming and/or blowing away debris stuck between rocks. The agitators can be made to have many properties and lengths depending upon the application at hand. The nozzle assembly 130B includes a distal port 131B having an aperture through which air can flow. The flange 132B can operate to hold the agitator assembly 134B or agitators in place, and can also operate to attach the agitators with the distal port 131B. The flange 132B can also operate to allow for easy replacement and adjustment of the agitators, for different applications or when they wear out or break.

A landscape maintenance system can also include an adjustable airflow regulator mechanism 150B having apertures 152B and 154B that can be opened or closed (or partially opened or closed) as desired. In some cases, the adjustable airflow regulator mechanism 150B can be part of or coupled with the nozzle assembly 130B. In some cases, the adjustable airflow regulator mechanism 150B can be part of or coupled with a wand assembly. In the embodiment shown in FIG. 1B, the adjustable airflow regulator mechanism 150B is in an open mode. In the embodiment shown in FIG. 1C, the adjustable airflow regulator mechanism 150C is in a closed mode (e.g. as regulator sleeve 156c has been adjusted as desired as indicated by arrow A to cover or partially cover the regulator apertures shown in FIG. 1B). In operation, the adjustable airflow regulator mechanism can be used in a closed mode primarily in vacuum applications to optimize the proportion of debris versus rocks sucked into the vacuum by allowing a desired amount of air to bypass the primary suction orifice of the nozzle (e.g. orifice defined by distal port 131C). In some cases, the adjustable airflow regulator mechanism can be adjusted to suit the type of debris and rock in different situations. This technology allows the tool to exploit the density differences between typical rocks and typical nuisance debris found accumulated in rock beds to achieve desired results.

As depicted in FIG. 1C, the landscape maintenance system can also include an angled head. For example, the nozzle assembly 130B can have a proximal port 133C and a distal port 131C. Each of these ports can be on opposing ends of an angled tube. As shown here, the proximal portion of the angled tube and the distal portion of the angled tube can provide an angle α. The angled head can be particularly useful when the landscape maintenance system is used in blower mode, to direct airflow downward into rocks for deeper and more efficient removal of debris between rocks. The angled head can also operate to concentrate airflow downward into cracks between rocks rather than across the surface of rocks. This can enhance directional and distance control over ejected debris plume and can help reduce rocks ejected from boundaries of rock beds due to pneumatic saltation. In vacuum applications, the angled head can allow the vacuum to vacuum deeper down into the cracks between rocks. Embodiments of the present invention encompass any of a variety of configurations which can provide an angled feature, such that during use, the central longitudinal axis of the wand assembly and the central longitudinal axis of the distal port are angularly offset by an angle (e.g. angle α).

It is appreciated that a nozzle assembly can be provided in any of a variety of shapes and configurations. For example, the nozzle assembly can be made in different tubing diameters depending upon application. Smaller diameter “shop vacuum-sized” nozzles (e.g. 2.5 inch diameter) such as the nozzle depicted in FIGS. 1B and 1C can be particularly effective in blower applications or in vacuum application when debris is of a finer size such as spruce needles and smaller leaves. Larger diameter nozzles (e.g. 3 to 5 inch diameter) such as the nozzle assembly 130D depicted in FIG. 1D can be particularly effective in vacuum applications where debris is larger or where average rock diameter is smaller. In some cases, a larger diameter nozzle can have a diameter of 4 inches. Exemplary leaf blower/vacuum decorative landscaping rock bed cleanup nozzles can be used in conjunction with a wand assembly which may include a rigid or semi rigid wand or tubing string (e.g. see wand assembly 120 depicted in FIG. 1A) that conveys or transfers mechanical compressional and tensional stresses from the hand or arm to the rocks on the ground, facilitating agitation while simultaneously transmitting high- or low-pressure air from the blower and or vacuum unit to the rocks in the bed.

FIG. 1D depicts a nozzle assembly 130D, perspective view, which in some cases may be particularly useful in vacuum applications. FIG. 1E shows nozzle assembly 130D in a side view. The nozzle assembly 130D can include a proximal end 132D that is configured to couple with a proximal end of a wand assembly, such as the wand assembly 120 depicted in FIG. 1A. As illustrated in the exploded view of FIG. 1F, the nozzle assembly 130D can include a distal section 155D that includes one or more agitators 135D (e.g. as part of an agitator assembly 134D), and a flange 133D that can couple the agitator(s) 135D or agitator assembly 134D with a distal end of the elbow 160D. Nozzle assembly 130D can also include a flange cover 150D, here shown in two parts 152D and 154D, which can help to secure the agitator(s) 135D with the flange 133D. In this way, the flange 133D can operate to hold the agitator assembly 134D or agitators in place, and can also operate to attach the agitators with the distal end of the elbow 160D. Removal of the flange cover 150D can also operate to allow for easy replacement and adjustment of the agitators, for different applications or when they wear out or break. When the flange cover 150D is removed (e.g. with reference to FIG. 1F), the agitator(s) 135D can be removed from the flange 133D. When the flange cover 150D is secured in place (e.g. with reference to FIGS. 1D and 1E), the agitator(s) 135D are locked in position relative to the flange 133D.

It can be seen that an agitator can have an elongate spine 136D and a proximal head 137D. The flange 133D can include one or more agitator apertures 139D, where an individual aperture is configured or sized to receive a spine of an agitator. The proximal head 137D can be sized so that it does not pass through the aperture 139D. In this way, when a flange cover 150D is placed against or coupled to the flange 133D, and for example secured to the flange 133D via one or more lid fasteners 131D, the flange cover 150D can operate to prevent the agitators 135D from moving in a distal direction. Hence, the nozzle assembly 130D can be used to vigorously stir rocks and other landscaping mulch or materials, while the agitators remain extending from the assembly. In some cases, an operator may choose to remove one or more agitators 135D (e.g. having a particular gauge, texture, shape, and/or length) and replace them with other agitators having different gauges, textured, shapes, and/or lengths.

FIG. 1G depicts a nozzle assembly 130G, perspective view, which in some cases may be particularly useful in blower applications. FIG. 1H shows nozzle assembly 130G in another perspective view. The nozzle assembly 130G can include a proximal end 132G that is configured to couple with a proximal end of a wand assembly, such as the wand assembly 120 depicted in FIG. 1A. FIG. 1I shows nozzle assembly 130G in another perspective view. As illustrated in the exploded view of FIG. 1J, the nozzle assembly 130G can include a distal section 155G that includes one or more agitators 135G (e.g. as part of an agitator assembly 134G), and a flange 133G that can couple the agitator(s) 135G or agitator assembly 134G with a distal end of the elbow 160G. Nozzle assembly 130G can also include a flange cover 150G, here shown in two parts 152G and 154G, which can help to secure the agitator(s) 135G with the flange 133G. In this way, the flange 133G can operate to hold the agitator assembly 134G or agitators in place, and can also operate to attach the agitators with the distal end of the elbow 160G. Removal of the flange cover 150G can also operate to allow for easy replacement and adjustment of the agitators, for different applications or when they wear out or break. When the flange cover 150G is removed (e.g. with reference to FIG. 1J), the agitator(s) 135G can be removed from the flange 133G. When the flange cover 150G is secured in place (e.g. with reference to FIGS. 1G to 1I), the agitator(s) 135G are locked in position relative to the flange 133G.

It can be seen that an agitator can have an elongate spine 136G and a proximal head 137G. The flange 133G can include one or more agitator apertures 139G, where an individual aperture is configured or sized to receive a spine of an agitator. The proximal head 137G can be sized so that it does not pass through the aperture 139G. In this way, when a flange cover 150G is placed against or coupled to the flange 133G, and for example secured to the flange 133G via one or more lid fasteners 131G, the flange cover 150G can operate to prevent the agitators 135G from moving in a distal direction. Hence, the nozzle assembly 130G can be used to vigorously stir rocks and other landscaping mulch or materials, while the agitators remain extending from the assembly. In some cases, an operator may choose to remove one or more agitators 135G (e.g. having a particular gauge, texture, shape, and/or length) and replace them with other agitators having different gauges, textured, shapes, and/or lengths. FIGS. 1K and 1L show nozzle assembly 130G in other exploded perspective views.

FIGS. 1M and 1N show perspective view of another embodiment of a nozzle assembly 130M having an agitator assembly 134M. As shown here, the nozzle assembly 130M can include a proximal end 132M that is configured to couple with a proximal end of a wand assembly, such as the wand assembly 120 depicted in FIG. 1A. Agitator assembly 134M includes multiple agitators 135M, which are in the shape of thin curved leaflets.

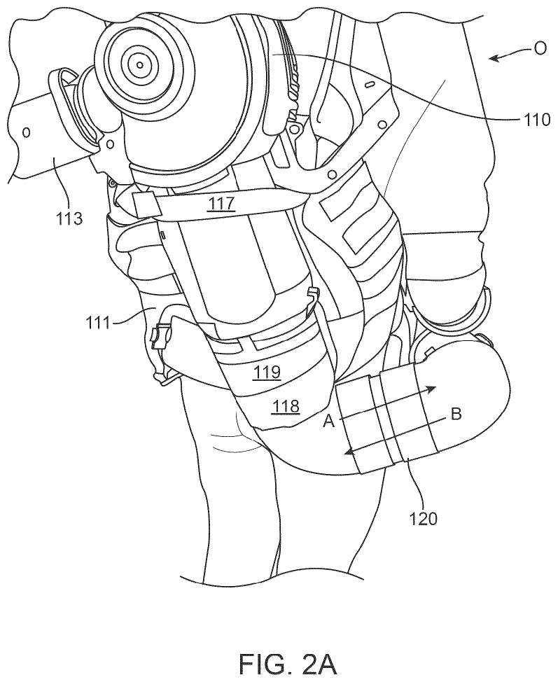

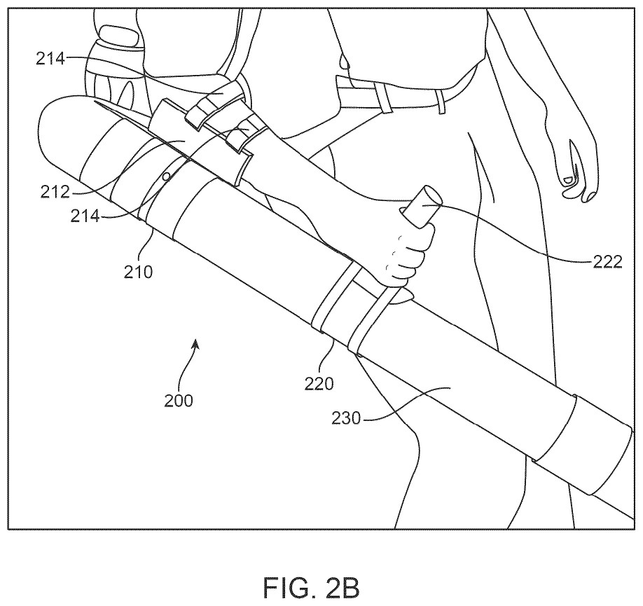

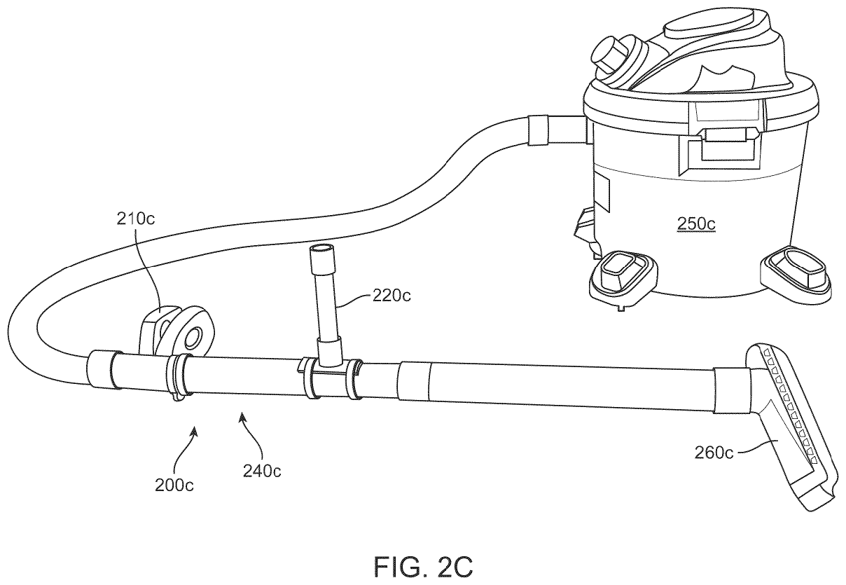

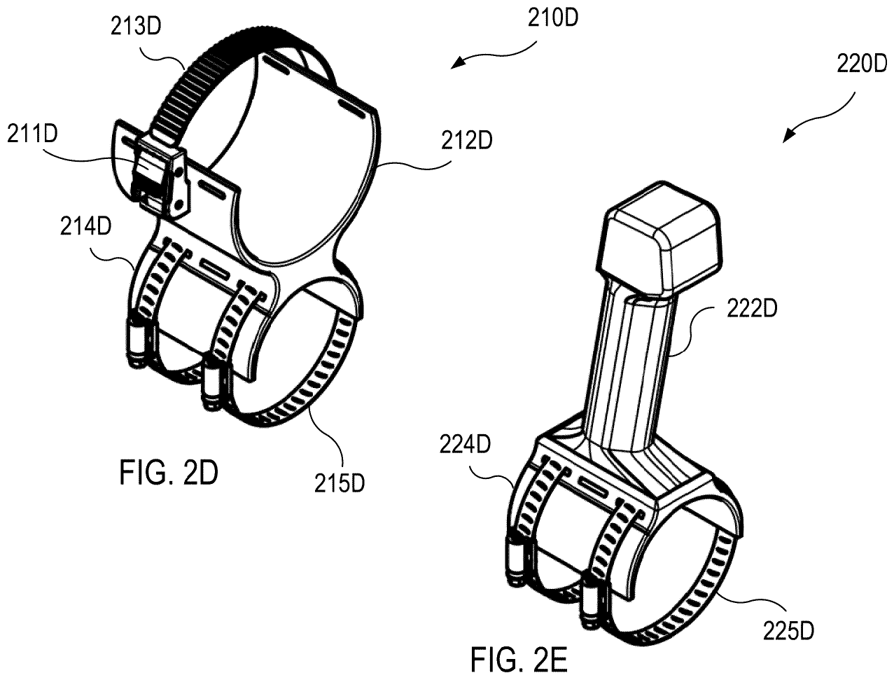

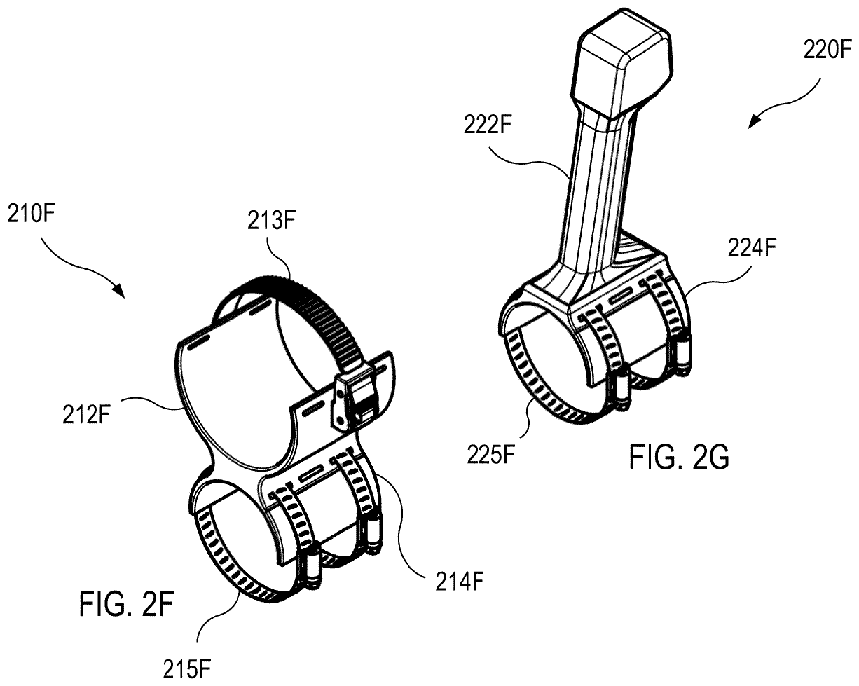

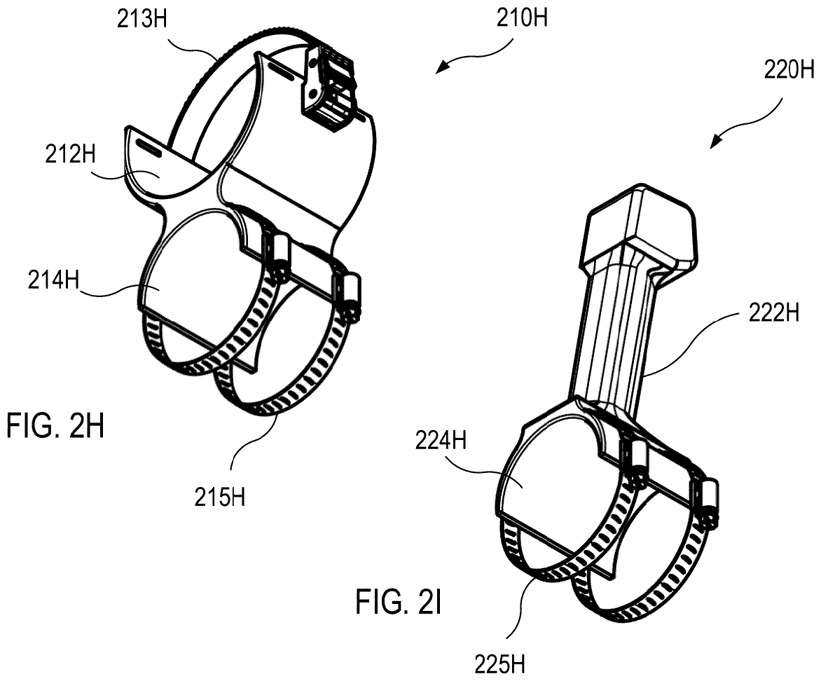

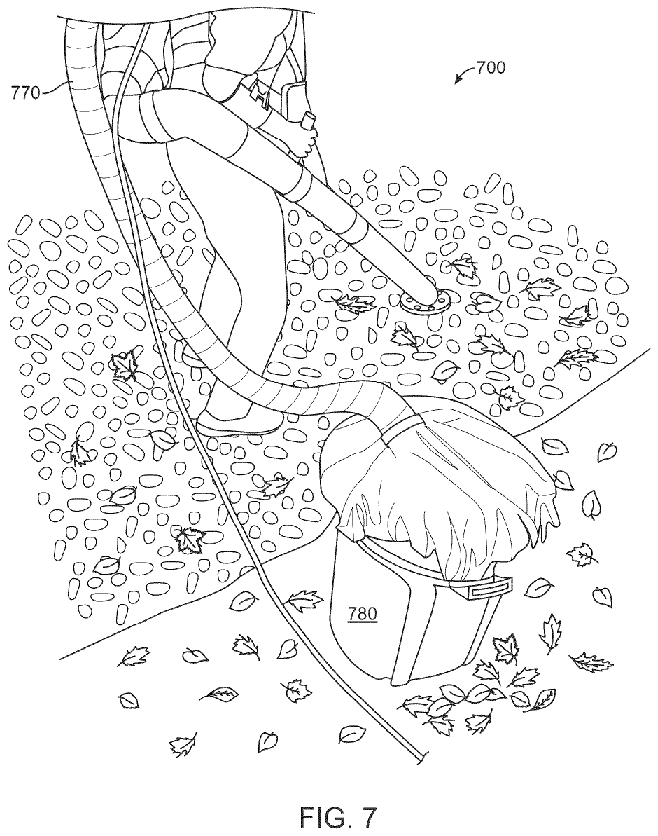

FIG. 2A provides a rear view of the operator O, illustrating the air flow generation mechanism 110 coupled with the wand assembly 120. As explained elsewhere herein, the air flow generation mechanism 110 can blow air outward through the wand assembly 120, as indicated by arrow A, or the air flow generation mechanism 110 can draw air inward through the wand assembly 120, as indicated by arrow B. In some cases, the air flow generation mechanism 110 may include a port 119. The port 119 may operate as an intake port for receiving airflow from the wand assembly 120 (e.g. in a vacuum application). The port 119 may operate as an exhaust port for delivering airflow to the wand assembly 120 (e.g. in a blower application). In some cases, air flow generation mechanism 110 may include a port 113. The port 113 may operate as an exhaust port for delivering or discharging airflow to an exhaust conduit (such as exhaust conduit 770 shown in FIG. 7).

FIG. 2B illustrates aspects of a wand forearm swing conversion kit 200, according to embodiments of the present invention. As shown here, a wand forearm swing conversion kit 200 can include a forearm cuff assembly 210 and a joystick handle assembly 220. A forearm swing conversion kit can allow any vacuum wand, blower wand, tubular wand, or tubing string to be converted into a forearm-swung unit. In some embodiments, a forearm cuff assembly 210 can include a forearm cuff 212 and one or more arm retention straps 214. A joystick handle assembly 220 can include a joystick handle 222 which can be grasped by the operator. In this way, a vacuum wand can provide a specific handle which can be grasped by the operator during operation, such that the operator can operate the wand using only one arm or forearm. As shown here, the other arm remains free. In this way, embodiments of the present invention are advantageous because they allow the operator to use the vacuum/blower without putting any unnecessary strain on their wrist, shoulders, and back. Moreover, embodiments of the present invention do not require the operator to remain in a bent-over position, and they do not induce unnecessary fatigue over prolonged use. The combination of a forearm cuff assembly 210 and a joystick handle assembly 220 used in conjunction with a rigid or semi-rigid wand body 230 can allow the weight of the wand assembly and nozzle assembly to hang from the shoulder joint of the operator, thus resulting in a decrease of fatiguing leverage on the elbow and wrist joints, and can also allow the operator to remain in a more upright or standing position during use.

The combination of a forearm cuff assembly 210 and a joystick handle assembly 220 can also provide the operator with an increased degree of control over the wand body 230 and allow for one-handed use. These advantages can help to reduce fatigue, increase comfort and control, and allow the use of longer and heavier vacuum and blower wands and nozzles. Longer vacuum wands allow the user to increase their reach into tight or hard-to-reach areas such as under low tree limbs or shrubs, window wells, or in other tight spaces. The implementation of a forearm cuff assembly 210 and a joystick handle assembly 220 can be used in many applications including but not limited to shop vacuum wands, household vacuum wands, carpet cleaning wands, insulation vacuum wands, truck-mounted or cart-mounted large-orifice debris vacuums. These technologies can be applied to existing tools as a retroactive modification kit, or the technologies can be designed and factory built into these tools from initiation. A wand forearm swing conversion kit 200 can be adjustable and can accommodate different diameter wands and different sized operators. A wand forearm swing conversion kit 200 can be made from a variety of materials depending upon the application.

FIG. 2C illustrates aspects of a wand forearm swing conversion kit 200C, according to embodiments of the present invention. As shown here, a wand forearm swing conversion kit 200C can include a forearm cuff assembly 210C and a joystick handle assembly 220C. Each of these elements can be coupled with a wand assembly 240C, which in turn can be in fluid communication with an air flow generation mechanism 250C (e.g. shop vac) and a nozzle assembly 260C. Any one or more of the advantages described above with regard to wand forearm swing conversion kit 200 may also be applicable to wand forearm swing conversion kit 200C.

FIG. 2D depicts a forearm cuff assembly 210D and FIG. 2E depicts a joystick handle assembly 220D, according to embodiments of the present invention. As shown in FIG. 2D, forearm cuff assembly 210D includes a forearm cradle 212D configured to support a forearm of an operator, and a wand engagement surface 214D configured to contact a wand assembly. The forearm cuff assembly 210D also includes a forearm strap 213D that can operate to secure forearm cradle 212D to the operator's forearm. In some cases, the forearm strap 213D can be adjustable, so as to accommodate any of a variety of forearm sizes. In some cases, a forearm cuff assembly may include multiple forearm straps. Further, the forearm cuff assembly 210D can also include a wand strap 215D that can operate to secure wand engagement surface 214D with a wand. In some cases, the wand strap 215D can be adjustable, so as to accommodate any of a variety of wand sizes. In some cases, a forearm cuff assembly may include multiple wand straps. In some cases, a forearm cuff assembly 210 can include an adjustment mechanism 211D, such as an adjustment buckle, which can be used to adjust the tightness of the strap 213D about the operator's forearm. As shown in FIG. 2E, joystick handle assembly 220D includes a joystick handle 222D configured to be grasped by an operator, and a wand engagement surface 224D configured to contact a wand assembly. The joystick handle assembly 220D can also include a wand strap 225D that can operate to secure wand engagement surface 224D with a wand. In some cases, the wand strap 225D can be adjustable, so as to accommodate any of a variety of wand sizes. In some cases, a joystick handle assembly may include multiple wand straps.

FIG. 2F depicts a forearm cuff assembly 210F and FIG. 2G depicts a joystick handle assembly 220G, according to embodiments of the present invention. As shown in FIG. 2F, forearm cuff assembly 210F includes a forearm cradle 212F configured to support a forearm of an operator, and a wand engagement surface 214F configured to contact a wand assembly. The forearm cuff assembly 210F also includes a forearm strap 213F that can operate to secure forearm cradle 212F to the operator's forearm. In some cases, the forearm strap 213F can be adjustable, so as to accommodate any of a variety of forearm sizes. In some cases, a forearm cuff assembly may include multiple forearm straps. Further, the forearm cuff assembly 210F can also include a wand strap 215F that can operate to secure wand engagement surface 214F with a wand. In some cases, the wand strap 215F can be adjustable, so as to accommodate any of a variety of wand sizes. In some cases, a forearm cuff assembly may include multiple wand straps. As shown in FIG. 2G, joystick handle assembly 220F includes a joystick handle 222F configured to be grasped by an operator, and a wand engagement surface 224F configured to contact a wand assembly. The joystick handle assembly 220F can also include a wand strap 225F that can operate to secure wand engagement surface 224F with a wand. In some cases, the wand strap 225F can be adjustable, so as to accommodate any of a variety of wand sizes. In some cases, a joystick handle assembly may include multiple wand straps.

FIG. 2H depicts a forearm cuff assembly 210H and FIG. 2I depicts a joystick handle assembly 220H, according to embodiments of the present invention. As shown in FIG. 2H, forearm cuff assembly 210H includes a forearm cradle 212H configured to support a forearm of an operator, and a wand engagement surface 214H configured to contact a wand assembly. The forearm cuff assembly 210H also includes a forearm strap 213H that can operate to secure forearm cradle 212H to the operator's forearm. In some cases, the forearm strap 213H can be adjustable, so as to accommodate any of a variety of forearm sizes. In some cases, a forearm cuff assembly may include multiple forearm straps. Further, the forearm cuff assembly 210H can also include a wand strap 215H that can operate to secure wand engagement surface 214H with a wand. In some cases, the wand strap 215H can be adjustable, so as to accommodate any of a variety of wand sizes. In some cases, a forearm cuff assembly may include multiple wand straps. As shown in FIG. 2I, joystick handle assembly 220H includes a joystick handle 222H configured to be grasped by an operator, and a wand engagement surface 224H configured to contact a wand assembly. The joystick handle assembly 220H can also include a wand strap 225H that can operate to secure wand engagement surface 224H with a wand. In some cases, the wand strap 225H can be adjustable, so as to accommodate any of a variety of wand sizes. In some cases, a joystick handle assembly may include multiple wand straps.

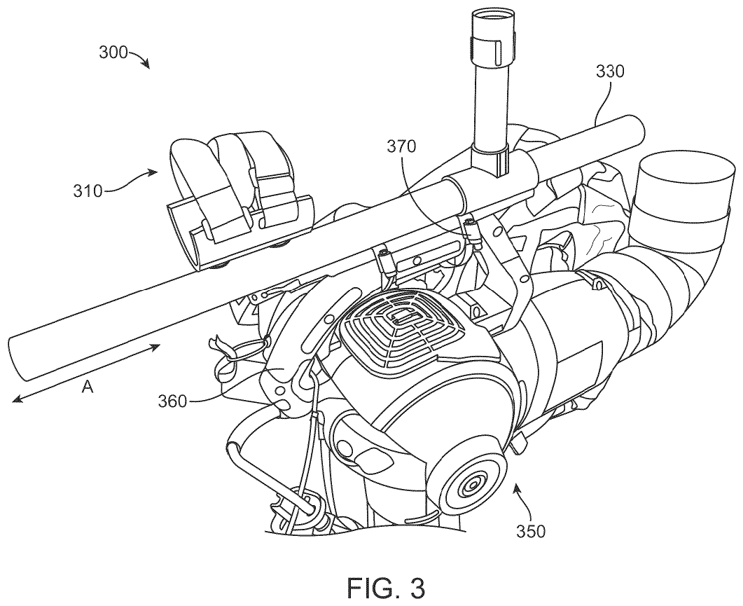

FIG. 3 depicts aspects of a forearm swing conversion kit 300, according to embodiments of the present invention. In some cases, kit 300 may be provided as a hand-swung leaf blower/vacuum forearm swing conversion kit. In some cases, a hand-swung leaf blower/vacuum forearm swing conversion kit can allow any handheld hand-swung leaf blower, handheld hand-swung leaf vacuum or handheld hand-swung leaf blower/vacuum combo unit to be converted into a forearm swung unit. In some embodiments, kit 300 may combine the use of three technologies to achieve these results, including a forearm cuff, a joystick-style handle, and an attachment/adjustment shaft. For example, kit 300 depicted in FIG. 3 includes a forearm cuff with adjustable arm-retention straps 310, which may also be referred to as a forearm cuff assembly. Kit 300 also includes a joystick-style handle 320, which may also be referred to as a joystick handle assembly. Further, kit 300 may include an attachment/adjustment shaft 330. As shown here, shaft 330 can be coupled with a handle 360 of an airflow generation device 350, by means of a coupling mechanism 370.

Many existing handheld hand-swung leaf blowers, handheld hand-swung leaf vacuums or handheld hand-swung leaf blower/vacuum combo units are designed to be held by one or two handles and are primarily supported, operated, and swung by the hand and wrist joint. It has been discovered that these designs put unnecessary strain on the hand and wrist, and they induce unnecessary fatigue over prolonged use. Many multi handle units have these same problems and in addition they require the use of two hands and often require the user to be bent over. The combination of forearm cuff, joystick-style handle, and attachment/adjustment shaft as disclosed herein allows the weight of the unit to hang from the shoulder joint, decreases fatiguing leverage on the elbow and wrist joints, and allows the user to remain more upright during use. The forearm cuff and joystick-style handle also increase control over the unit and allow for one-handed use. These advantages reduce fatigue, increase comfort and control, and allow longer operation. Conversion kits as disclosed herein can be attached to any unit designed with handles similar to those labeled 360 in FIG. 3 which includes the vast majority of handheld hand-swung leaf blowers, handheld hand-swung leaf vacuums and handheld hand-swung leaf blower/vacuum combo units currently available commercially. Hand-swung leaf blower/vacuum forearm swing conversion kits are adjustable using the attachment/adjustment shaft to allow the user to find the correct balance point of the unit for optimal use. For example, the user may adjust the positioning of the attachment shaft 330 relative to the handle 360, as indicated by arrow A in FIG. 3. A hand-swung leaf blower/vacuum forearm swing conversion kit can be made from a variety of materials depending upon the application.

FIGS. 4A and 4B depict a perspective view and an end view, respectively of a forearm swing conversion kit 400, according to embodiments of the present invention. A kit may also include a coupling mechanism, as shown in FIG. 3. Forearm swing conversion kits as disclosed herein can also be used on many string trimmers/weed whackers.

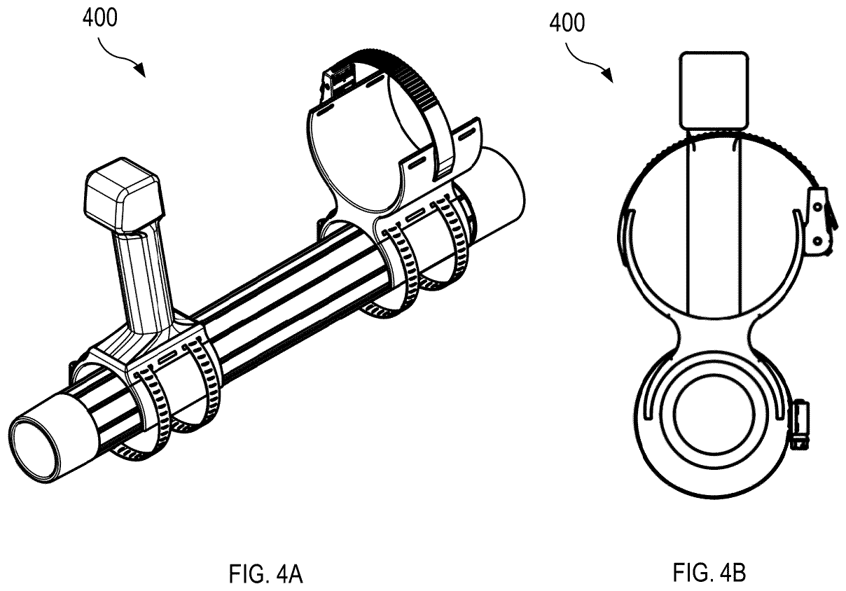

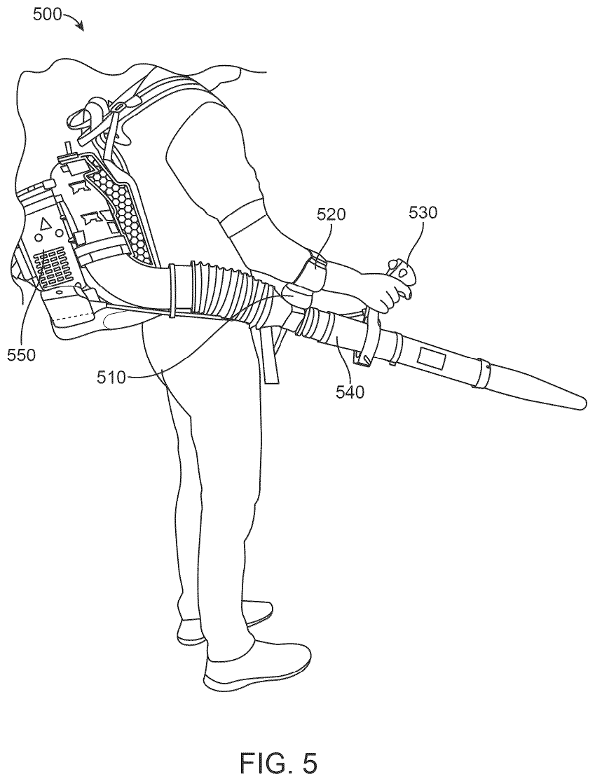

FIG. 5 depicts a standing operator using a system 500 having a forearm cuff 510 with adjustable arm-retention straps 520 combined with a joystick-style control handle 530, coupled with a wand 540 of a backpack mounted leaf blower unit 550. The cuff 510 and straps 520 allow for increased control of the wand and decreased fatigue during extended use.

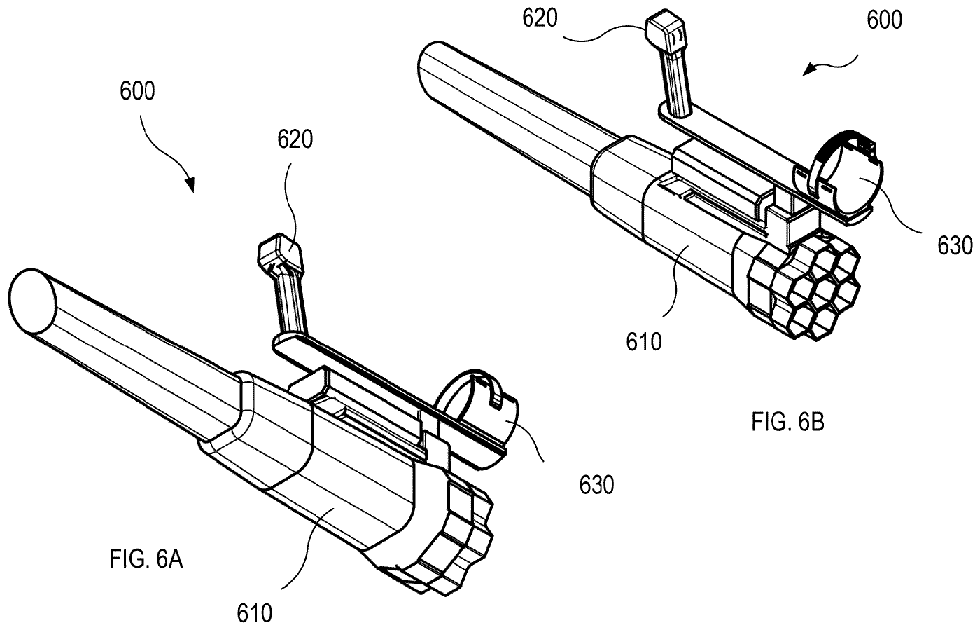

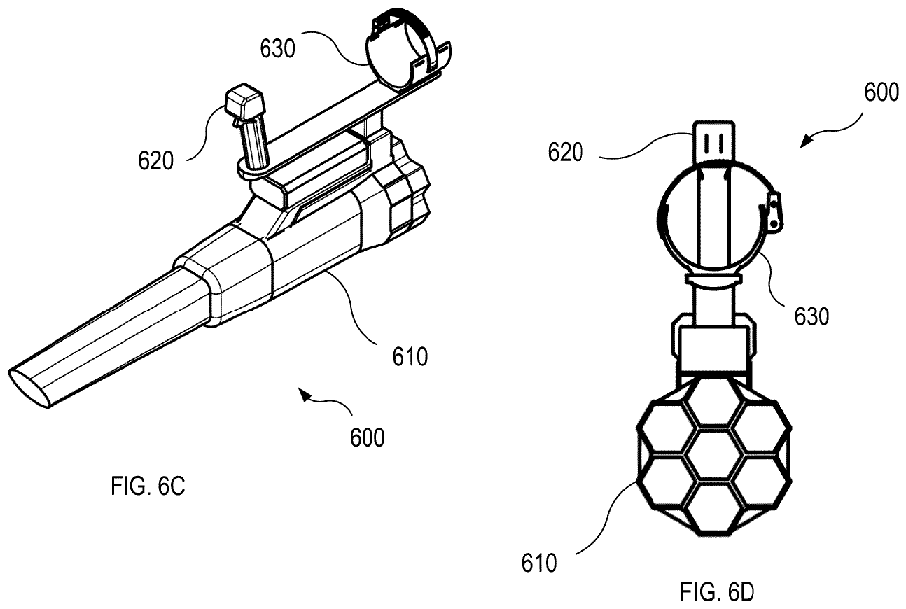

As an alternative to a retroactive conversion kit, handheld hand-swung leaf blowers, handheld hand-swung leaf vacuums or handheld hand-swung leaf blower/vacuum combo units could be designed and factory built from initiation to have the three technologies included in the hand-swung leaf blower/vacuum forearm swing conversion kit instead of their current handles. Examples of such a system is depicted in FIGS. 6A to 6D. As shown here, a system 600 may include an airflow generation device 610, a joystick handle or joystick handle assembly 620, and an adjustable cuff or forearm cuff assembly 630. In some embodiments, system 600 may be provided as a forearm swing leaf blower.

FIG. 7 depicts aspects of a landscape maintenance system 700, which can include an air flow generation mechanism, a wand assembly, and a nozzle assembly, for example as described herein with reference to FIG. 1. As illustrated here, system 700 may also include or be coupled with an exhaust conduit 770, the distal end of which can be placed inside of a garbage bag, trash bucket, or other receptacle 780.

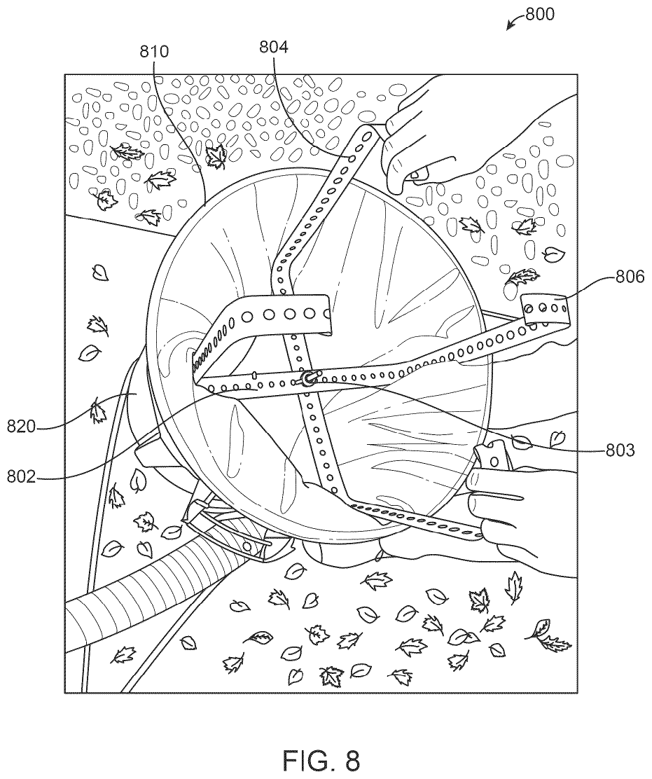

As shown in FIG. 8, a trash bag retention cage or frame 800 can be placed inside of a bag 810 such as a garbage bag, and the bag 810 and the frame 800 can be placed inside of a garbage can 830. In this way, the frame 800 operates to keep the bag 820 in an open configuration while the operation of a landscape maintenance system (e.g. system 700 depicted in FIG. 7) allows leaves and other debris to be deposited into the bag 810. As shown here, the frame can include one or more lower horizontal members 802, one or more vertical members 804, and one or more upper horizontal members 806. In this embodiment, there are two lower horizontal members, coupled via a connection mechanism 803. A trash bag retention cage 800 allows the use of trash bag liners in the debris receptacles of most shop vacuums and trashcan based leaf collection systems while vacuuming so that debris is collected directly into a trash bag eliminating the need to transfer debris from the vacuum into a trash bag after vacuuming. In use, trash bags typically have a tendency to flap around in the debris receptacle during vacuuming and can end up covering and clogging the filter or exhaust air outlets, rendering the vacuum inoperable. Advantageously, the trash bag retention cage 800 holds the sides of the trash bag 810 down so that the bag cannot flap around and cover the filter or exhaust outlet. When vacuuming is complete the trash bag retention cage 800 can be shaken clean of debris and removed from the trash bag 810 in the debris receptacle 820 so that the trash bag 810 and contained debris can be removed from the debris receptacle 820 and disposed of easily.

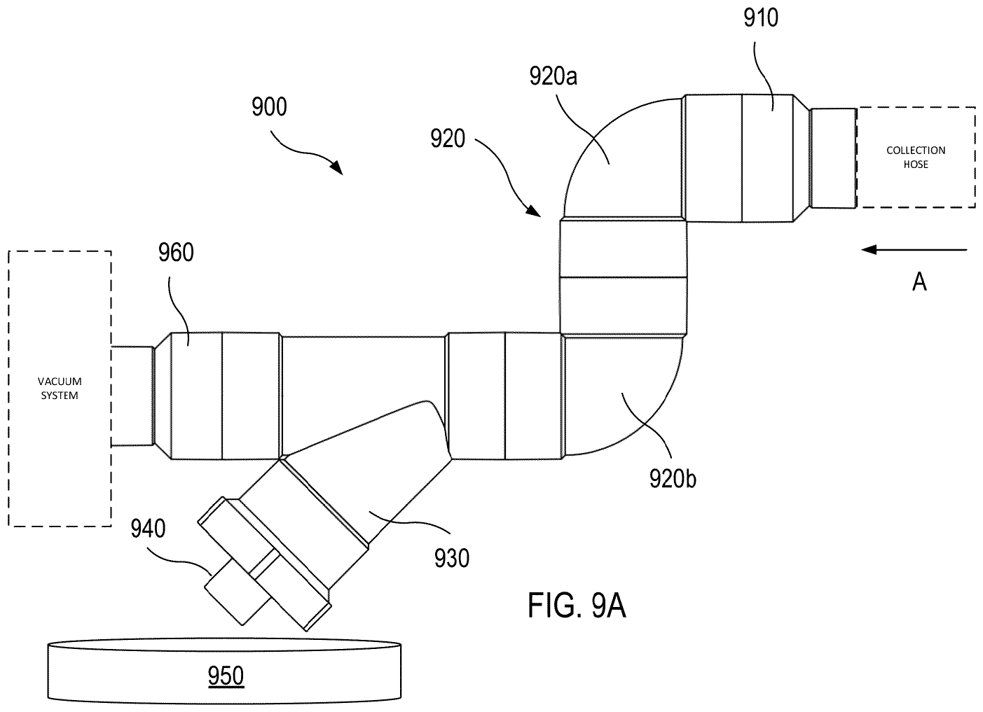

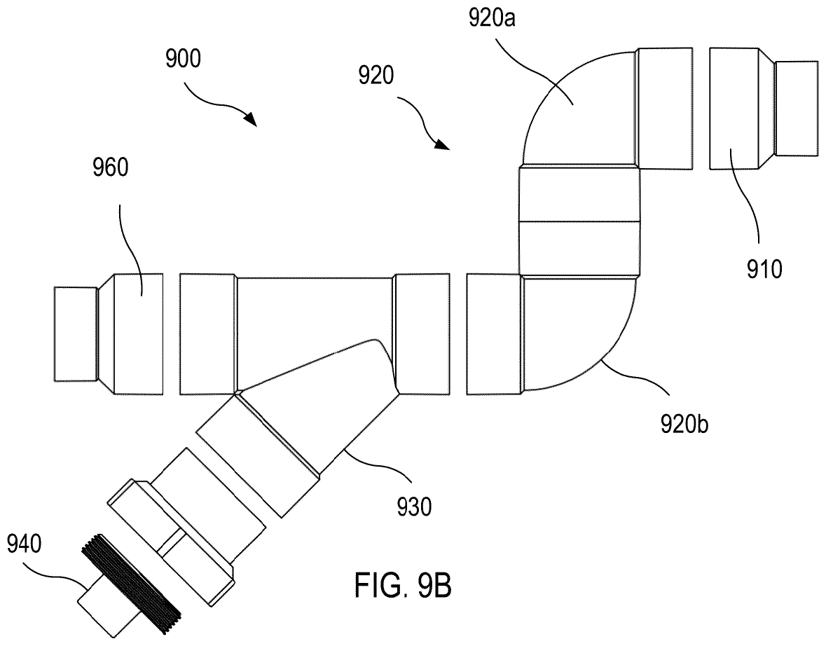

FIG. 9A depicts aspects of an exemplary rock extractor system 900, according to embodiments of the present invention. In some cases, extractor system 900 can be provided as an inline low-pressure/vacuum mechanical rock extractor. An extractor system 900 such as an inline low-pressure/vacuum mechanical rock extractor can be designed to be an efficient and highly effective inline separator of rocks from all other lower density debris sucked into a vacuum system. The extractor system 900 can attach with an intake such as an intake hose part of the vacuum upstream of the debris receptacle. In exemplary embodiments, the intake hose part of the vacuum will have the same diameter as the smallest diameter of tubing dilator 910. The extractor system 900 can exploit the density differences between landscaping rock and typical yard debris such as leaves and evergreen needles and employs a combination of percussion, centrifugal force, reverse Venturi effect, and gravity to separate rocks from less dense debris in the low-pressure/vacuum stream. In some cases an extractor system 900 can be used in applications of cleaning unwanted debris out of decorative landscaping rock beds. Efficiently cleaning decorative landscaping rock beds can be a difficult task with the ultimate goal being the removal of unwanted debris out of the rock bed by separating it from the rock while leaving the rock behind. Most existing methods either are not effective at removing satisfactory percentages of the unwanted debris or remove unsatisfactorily high amounts of rock with the debris. Once rocks are sucked into the vacuum system and deposited in the debris receptacle, they can be difficult to separate from the unwanted debris in order to return them to the rock bed. Even with highly efficient methods of vacuuming rock beds some rocks are inevitably drawn into the vacuum nozzle along with the unwanted debris. This technology easily separates those rocks out for easy return back to the rock bed, and a system 900 can include various components, such as a tubing dilator 910, a tubing S-bend 920, a diverter tube 930, and end cap 940, a collection bucket 950, and a tubing reducer 960. In operation the inline low-pressure/vacuum mechanical rock extractor system can work as follows. Rocks and lower density yard debris are sucked into the vacuum hose or conduit and travel at high velocity through the hose or conduit, as indicated by arrow A, toward the main vacuum unit or system. The rocks, debris, and air travel through the tubing dilator 910, which induces a reverse Venturi effect in the airstream. This reduces the velocity of the airstream and introduces turbulent vortices into the airstream. The rocks then strike the outside curvature of the first bend or curvature (920a) of the tubing S-bend 920 with percussive force, greatly reducing their velocity and momentum. The rocks then travel through and around the second bend or curvature (920b) of the S-Bend. Centrifugal force forces the rocks to the outside edge of the curvature towards the bottom of the tubing and into the diverter tube 930. Vortices in the airstream set up by the reverse Venturi effect then continuously winnow out the lower density debris material back into the airstream and carry it through the tubing reducer 960 where a Venturi effect is induced carrying the lower density debris all the way into the debris receptacle of the vacuum. The rocks accumulate in the diverter tube 930 where they can be removed by removing the end cap 940 and allowing the rocks to dump into the collection bucket 950 where they can be easily carried back to the rock bed from whence they came. The tubing diameters of the example shown here can be 2.5″ for the main vacuum hose and 3″ for the main portion of the extractor. The tubing diameters of the hose and extractor can be varied depending upon the application. FIG. 9B provides an exploded view of an exemplary rock extractor system 900, according to embodiments of the present invention.

With returning reference to FIGS. 1A and 2A, aspects of a leaf blower/vacuum conversion system are now described. In some embodiments, a leaf blower/vacuum conversion system may combine various aspects or features of new technologies described herein, along with existing leaf blower/vacuum, debris mulching and collection systems. For example, a leaf blower/vacuum conversion system can add or include a handheld-to-backpack support conversion, a unit specific adapter, and/or a forearm swung wand to any existing handheld hand-swung leaf blower/vacuum combo unit along with the leaf blower/vacuum decorative landscaping rock bed cleanup nozzle, and the trash bag retention cage to create a portable, fully-integrated rock bed, lawn, and yard cleaning system unmatched by any system currently commercially available.

For example, a handheld-to-backpack shoulder support conversion (including shoulder straps 112 and 114 shown in FIG. 1A and backpack body 111 shown in FIG. 2A) can convert handheld hand-swung leaf blowers, handheld hand-swung leaf vacuums or handheld hand-swung leaf blower/vacuum combo units into backpack supported units. As shown in FIG. 2A, an airflow generation mechanism (e.g. vacuum and/or blower device) 110 can be secured to the backpack body 111 via a coupling mechanism 117 such as a strap. In some cases, a landscape maintenance system may include a unit specific adapter 118 as shown in FIG. 2A, which provides fluid communication or an airflow conduit between the wand 120 and the airflow generation mechanism 110. In some cases, a unit specific adapter 118 can be an adapter that is specific to a particular existing model of handheld hand-swung leaf blower/vacuum combo unit, that allows it to attach to a forearm swung wand. In some cases, the wand 120 can be a forearm swung wand. In some cases, the wand 120 can be a forearm swung leaf blower/vacuum wand. A leaf blower/vacuum conversion system can be designed to be very modular and can support many configurations depending upon application. Vacuum and blower nozzles can be easily swapped, tubing wand length can be easily changed, wand tubing diameter can vary, and the system can be easily taken apart in the event that any part of the system clogs. The system 100 as seen in FIG. 1 can be combined with an exhaust conduit 770 (as shown in FIG. 7) the distal end of which can be placed inside of a garbage bag, trash bucket, or other receptacle 780. In some cases, as shown in FIG. 8, a trash bag retention cage or frame 800 can be placed inside of a bag 810 such as a garbage bag, and the bag 810 and the frame 800 can be placed inside of a garbage can 830 (which may be analogous to or replaced with the receptacle 780 of FIG. 7). In this way, a complete landscape maintenance system can be configured for vacuuming, mulching, and collecting leaves off a grass surface.

Landscape maintenance systems and methods disclosed herein can provide many advantages over currently available landscape tools and techniques. For example, existing backpack leaf blowers have several shortcomings. For example, they have trouble getting air penetration deep enough into cracks between rocks. They also have trouble agitating rocks enough to loosen debris without causing saltation and ejection of rocks from boundaries of rock beds. Further, they tend to saltate and eject top layer of rocks along with debris without cleaning deeper layers of rock. What is more, they lack forearm cuffs for additional control and comfort. Further, when using existing backpack leaf blowers, it is hard to reach under shrubs, bushes, and low trees. Existing shop vacuum have shortcomings as well. For example, they can either skim the easy, loose debris off the top of rock bed leaving most of the deep and stuck debris behind or sucks up too many rock with the debris in a “baby-out-with-the-bathwater” scenario. What is more, they cannot easily stir or agitate rocks to get deep trapped debris. Also, they cannot easily adjust to the type of debris or rocks in different situations. Further, they tend to clog with larger debris or with rocks. Existing hand-held vacuum tubes cause fatigue in the wrist, shoulder, and back of the operator. They also provide little control over longer tube strings which are often needed to reach under trees and shrubs. What is more, when using such existing techniques, it is difficult to keep nozzle the proper distance off the ground to effectively skim debris off the top of rock bed. Further, with existing techniques, trash bags in debris receptacle cover exhaust the air outlet. Existing leaf blower/vacuum combinations have shortcomings too. For example, current leaf vacuums have no mechanism to agitate or stir the rocks in the rock bed. Thus, they are inefficient at removing deep debris or debris stuck between rocks. They are also somewhat heavy, and they are supported or held and swung by hand making them awkward and fatigue-inducing.

Although embodiments of the present invention have been explained in relation to one or more preferred embodiments, it is to be understood that many other possible modifications and variations can be made without departing from the spirit and scope of the invention.

All features of the described systems and devices are applicable to the described methods mutatis mutandis, and vice versa. Embodiments of the present invention encompass kits having systems for maintaining landscape features as disclosed herein. In some embodiments, the kit includes one or more systems for maintaining landscape features, along with instructions for using the system for example according to any of the methods disclosed herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. In addition, each reference provided herein in incorporated by reference in its entirety to the same extent as if each reference was individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

What is claimed is:

1. A landscape maintenance system, comprising:
an air flow generation mechanism;
a nozzle assembly; and
a wand assembly coupled with the air flow generation mechanism and the nozzle assembly,
wherein the nozzle assembly includes a flange, a flange cover, and an agitator assembly.

2. The landscape maintenance system of claim 1, wherein the agitator assembly comprises an agitator having an elongate spine and a proximal head.

3. The landscape maintenance system of claim 2, wherein the flange comprises an agitator aperture, wherein the agitator aperture is configured to receive the elongate spine of the agitator, and wherein the proximal head of the agitator is sized so that it cannot pass through the agitator aperture of the flange.

4. The landscape maintenance system of claim 1, wherein the nozzle assembly further includes a lid fastener configured to secure the flange cover to the flange.

5. The landscape maintenance system of claim 1, wherein the flange cover comprises a first part and a second part.

6. The landscape maintenance system of claim 5, wherein the first part of the flange cover has a semi-circular shape.

7. The landscape maintenance system of claim 1, wherein the flange cover is removable from the flange.

8. The landscape maintenance system of claim 1, wherein the agitator is removable from the flange when the flange cover is removed from the flange, and wherein the agitator is locked in position relative to the flange when the flange cover is secured with the flange.

9. The landscape maintenance system of claim 1, wherein the agitator assembly comprises an agitator having an elongate spine and a proximal head, and wherein the flange cover covers the proximal head of the agitator when the flange cover is coupled with the flange.

10. The landscape maintenance system of claim 1, wherein the agitator assembly comprises an agitator having an elongate spine and a proximal head, and wherein the agitator does not extend into the flange cover when the flange cover is coupled with the flange.

11. The landscape maintenance system of claim 1, wherein the agitator assembly comprises an agitator having n elongate spine and a proximal head, wherein the flange comprises an agitator aperture, wherein the agitator aperture is configured to receive the elongate spine of the agitator, wherein the proximal head of the agitator is sized so that it cannot pass through the agitator aperture of the flange, and wherein the nozzle assembly further includes a lid fastener configured to secure the flange cover to the flange.

12. The landscape maintenance system of claim 1, wherein the agitator assembly comprises an agitator having an elongate spine and a proximal head, wherein the flange cover covers the proximal head of the agitator when the flange cover is coupled with the flange, and wherein the agitator does not extend into the flange cover when the flange cover is coupled with the flange.

13. The landscape maintenance system of claim 1, wherein the nozzle assembly further includes one or more lid fasteners configured to secure the flange cover to the flange.

14. The landscape maintenance system of claim 1, wherein the nozzle assembly comprises a distal port having a central longitudinal axis, wherein the agitator assembly comprises an agitator having a proximal head that is located a first distance from the central longitudinal axis and an elongate spine having a distal end that is located a second distance from the central longitudinal axis, and wherein the second distance is greater than the first distance.

15. The landscape maintenance system of claim 1, wherein the nozzle assembly comprises a distal port having a central longitudinal axis, wherein the agitator assembly comprises a plurality of agitators each having a proximal end and a distal end, and wherein the plurality of agitators extend distally from the flange in a radially divergent pattern about the central longitudinal axis of the distal port of the nozzle assembly so that the distal end of each agitator is further away from the central longitudinal axis of the distal port of the nozzle assembly than the corresponding proximal end of each agitator.

16. The landscape maintenance system of claim 1, wherein the nozzle assembly further includes an adjustable airflow regulator mechanism.

17. The landscape maintenance system of claim 16, wherein the adjustable airflow regulator mechanism comprises one or more apertures.

18. The landscape maintenance system of claim 16, wherein the adjustable airflow regulator mechanism comprises a regulator sleeve.

19. The landscape maintenance system of claim 16, wherein the adjustable airflow regulator mechanism is operable to transition between an open mode and a closed mode.

20. The landscape maintenance system of claim 1, wherein the nozzle assembly comprises a proximal end having a first shape configured to couple with the wand assembly and a distal port having a second shape, and wherein the second shape is different from the first shape.

21. The landscape maintenance system of claim 1, wherein the nozzle assembly comprises a proximal end having a first cross sectional area configured to couple with the wand assembly and a distal port having a second cross sectional area, and wherein the second cross sectional area is different from the first cross sectional area.
